(19) United States
(12) Patent Application Publication
(10) Pub. No.: US 2024/0262383 A1
(43) Pub. Date: Aug. 8, 2024

(54) SYSTEM AND METHOD FOR GLOBALLY WAKING UP A FLEET OF AUTONOMOUSLY GUIDED VEHICLES

(71) Applicant: Ford Motor Company, Dearborn, MI (US)

(72) Inventors: Joshua Magill, Commerce Township, MI (US); Keith Clark, Detroit, MI (US); Candace Carolyn Glasgow, Beverly Hills, MI (US); Kennadi Rankin, Saint Clair Shores, MI (US); Abdul Salam Kashif Mohammed, Novi, MI (US); Daniel Lockwood, White Lake, MI (US); Jordan Gervais, Windsor (CA); Dean Colwell, Dearborn, MI (US); Robert Alan Jones, Ypsilanti, MI (US)

(73) Assignee: Ford Motor Company, Dearborn, MI (US)

(21) Appl. No.: 18/417,595

(22) Filed: Jan. 19, 2024

Related U.S. Application Data
(60) Provisional application No. 63/483,639, filed on Feb. 7, 2023.

(51) Int. Cl. B60W 60/00

(52) U.S. Cl. CPC B60W 60/001; B60W 2510/305; B60W 2556/45

(57) ABSTRACT

A method for activating a wake-up module of an autonomous guided vehicle (AGV) when the AGV is operating in a standby state, determining whether a global wake-up command was broadcasted by a fleet management system, and activating an on-state associated with the AGV in response to determining that the global wake-up command was broadcasted by the fleet management system.

### CROSS-REFERENCE TO RELATED APPLICATION

This application claims the benefit of and priority to U.S. Provisional Application No. 63/483,639 filed on Feb. 7, 2023, and titled “SYSTEM AND METHOD FOR GLOBALLY WAKING UP A FLEET OF AUTONOMOUS GUIDED VEHICLES”, the contents of which are incorporated herein by reference in its entirety.

### FIELD

The present disclosure relates to systems and methods for remotely waking-up a fleet of autonomously guided vehicles.

### BACKGROUND

The statements in this section merely provide background information related to the present disclosure and may not constitute prior art.

Autonomous guided vehicles (AGVs) are generally used to transport material or product through a manufacturing facility. For example, AGVs are employed to ferry parts throughout a facility or convey them through an assembly process of the manufacturing facility. The size of an AGV fleet may depend on the size or scale of autonomous material/part/products handling.

AGVs may be powered down at the end of a production shift and prior to any prolonged production downtime (e.g., weekends, holidays, shutdowns, etc.) to conserve battery. AGVs can either be powered down manually, one by one, or centrally via a fleet management system. However, powering on the AGVs before production is resumed, which takes increasing time as the fleet size of AGVs increases.

The present disclosure addresses these and other issues related to the waking-up of the fleet of AGVs.

### SUMMARY

This section provides a general summary of the disclosure and is not a comprehensive disclosure of its full scope or all of its features.

The present disclosure provides a method comprising: activating a wake-up module of an autonomous guided vehicle (AGV) when the AGV is operating in a standby state; determining, by the wake-up module, whether a global wake-up command was broadcasted by a fleet management system; and activating an on-state associated with the AGV in response to determining that the global wake-up command was broadcasted by the fleet management system; wherein the wake-up module is coupled to a first low-power circuit associated with the AGV and wherein the global wake-up command is broadcasted via an ultra-wide band network, Bluetooth®, WIFI, a CV2X protocol, a public cellular network, or a private cellular network; wherein activating the on-state associated with the AGV further comprises: causing the wake-up module to be charged via a main power source associated with the AGV, wherein the first low-power circuit is coupled to the main power source; further comprising: activating the standby state associated with the AGV in response to a global shut-off command broadcasted by the fleet management system; activating the wake-up module, wherein the wake-up module is powered by an auxiliary power source; determining whether the global wake-up command was broadcasted by the fleet management system; and activating a sleep state associated with the AGV in response to determining that the global wake-up command was not broadcasted by the fleet management system; further comprising: re-activating the wake-up module when the AGV is operating in a standby state and in response to a defined period of time elapsing, according to a predetermined schedule, or an initiation of a remote command; wherein a second low-power circuit couples the wake-up module to the auxiliary power source; and wherein activating the wake-up module of the AGV is in response to a defined period of time elapsing, according to a predetermined schedule, or an initiation of a remote command.

The present disclosure provides a system comprising: a vehicle control system configured to: activate a wake-up module of an autonomous guided vehicle (AGV) when the AGV is operating in a standby state, determine, by the wake-up module, whether a global wake-up command was broadcasted by a fleet management system, and activate an on-state associated with the AGV in response to determining that the global wake-up command was broadcasted by the fleet management system; and a fleet management system configured to: broadcast the global wake-up command; wherein the wake-up module is coupled to a first low-power circuit associated with the AGV and wherein the global wake-up command is broadcasted via an ultra-wide band network, Bluetooth®, WIFI, a CV2X protocol, a public cellular network, or a private cellular network; wherein the vehicle control system is further configured to: cause the wake-up module to be charged via a main power source associated with the AGV, wherein the first low-power circuit is coupled to the main power source; wherein the vehicle control system is further configured to: activate the standby state associated with the AGV in response to a global shut-off command broadcasted by the fleet management system; activate the wake-up module, wherein the wake-up module is powered by an auxiliary power source; determine whether the global wake-up command was broadcasted by the fleet management system; and activate a sleep state associated with the AGV in response to determining that the global wake-up command was not broadcasted by the fleet management system; wherein the vehicle control system is further configured to: re-activate the wake-up module when the AGV is operating in a standby state and in response to a defined period of time elapsing, according to a predetermined schedule, or an initiation of a remote command; wherein a second low-power circuit couples the wake-up module to the auxiliary power source; and wherein activating the wake-up module of the AGV is in response to a defined period of time elapsing, according to a predetermined schedule, or an initiation of a remote command.

The present disclosure provides one or more non-transitory computer-readable media storing processor-executable instructions that, when executed by at least one processor, cause the at least one processor to: activate a wake-up module of an autonomous guided vehicle (AGV) when the AGV is operating in a standby state; determine, by the wake-up module, whether a global wake-up command was broadcasted by a fleet management system; and activate an on-state associated with the AGV in response to determining that the global wake-up command was broadcasted by the fleet management system; wherein the wake-up module is coupled to a first low-power circuit associated with the AGV and wherein the global wake-up command is broadcasted via an ultra-wide band network, Bluetooth®, WIFI, a CV2X protocol, a public cellular network, or a private cellular network; wherein the processor-executable instructions that, when executed by the at least one processor, activate the on-state associated with the AGV, further causes the at least one processor to: cause the wake-up module to be charged via a main power source associated with the AGV, wherein the first low-power circuit is coupled to the main power source; wherein the at least one processor is further caused to: activate the standby state associated with the AGV in response to a global shut-off command broadcasted by the fleet management system; activate the wake-up module, wherein the wake-up module is powered by an auxiliary power source and wherein a second low-power circuit couples the wake-up module to the auxiliary power source; determine whether the global wake-up command was broadcasted by the fleet management system; and activate a sleep state associated with the AGV in response to determining that the global wake-up command was not broadcasted by the fleet management system; wherein the at least one processor is further caused to: re-activate the wake-up module when the AGV is operating in a standby state and in response to a defined period of time elapsing, according to a predetermined schedule, or an initiation of a remote command; and wherein activating the wake-up module of the AGV is in response to a defined period of time elapsing, according to a predetermined schedule, or an initiation of a remote command.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an overall system for waking up a vehicle in accordance with various implementations;

FIG. 2 illustrates an example vehicle associated with the system shown in FIG. 1 in accordance with various implementations;

FIG. 3 illustrates a functional block diagram of an example manufacturing environment in accordance with various implementations;

FIG. 4 is a flowchart illustrating an example method for waking up the vehicle shown in FIG. 2 in accordance with various implementations; and

FIG. 5 illustrates a flowchart illustrating another example method for waking up the vehicle shown in FIG. 2 in accordance with various implementations.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a means for remotely waking-up a fleet of AGVs, regardless of the number of AGVs in the fleet. With one or more examples described herein, waking-up the fleet of AGVs is no longer performed by manually powering on each of the AGVs when it is time to power on the AGVs before production is resumed. As such, a large fleet size of AGVs that would otherwise require substantial time and labor resources associated with only waking-up the AGVs can be powered up in a shorter time period. As an example, when the fleet size of AGVs is greater than one hundred, it may take an operator approximately 45 minutes or more prior to each and every production shift to manually turn on each AGV. Additionally, with a large fleet size, one or more of the AGVs may not be turned on by the operator due to, for example, time constraints, the AGVs being in an uncommon/irregular area in the facility, the AGVs being inside an automation cell, and/or the AGVs inadvertently not being turned on. Accordingly, not turning on each AGV of the fleet may result in extended downtime only resolved by the operator revisiting the missed AGV to manually power the missed AGV. By employing a global wakeup function in accordance with one or more herein described examples, the time to power on a fleet of AGVs is substantially reduced. Furthermore, the global wakeup function activates each AGV and thereby reduces the likelihood of, or eliminates, a set of AGVs not being turned on using the methods and systems described herein.

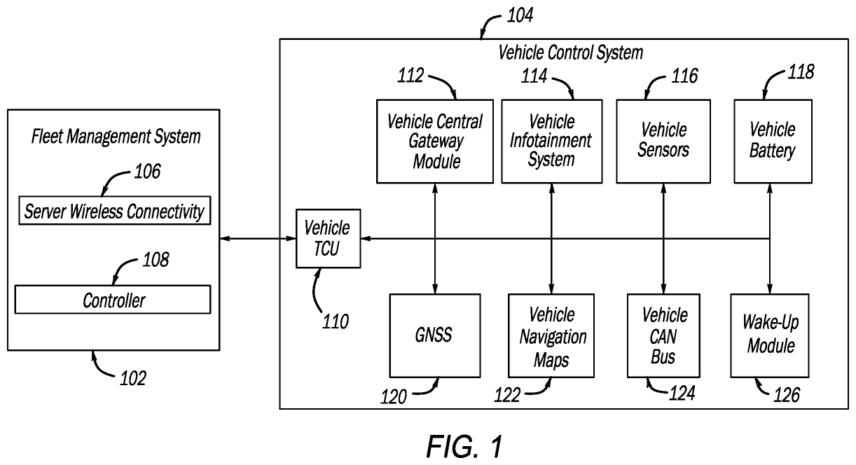

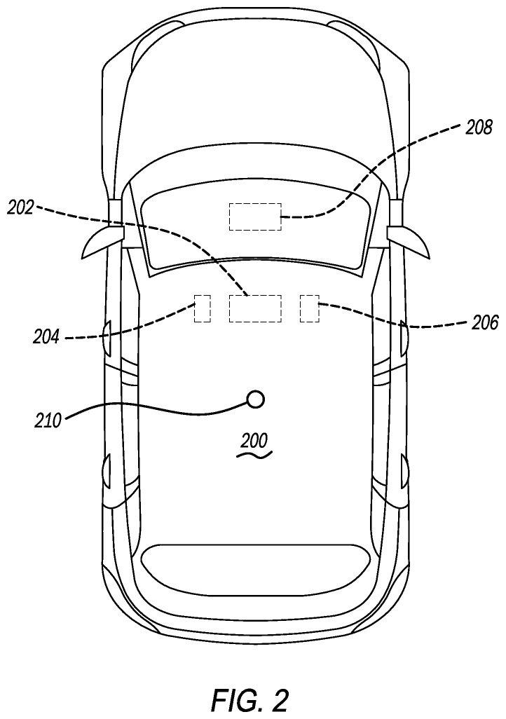

FIG. 1 shows a schematic block diagram illustrating a communicative system 100 associated with waking-up a vehicle (e.g., a vehicle 200, shown in FIG. 2). It is understood that the communicative system 100 may also be associated with waking-up more than one vehicle or individual vehicles (e.g., a fleet of vehicles). The communicative system 100 generally includes a fleet management system 102 and a vehicle control system 104. The fleet management system 102 can include a server wireless connectivity unit 106 and a controller 108. The fleet management system 102 is configured to wirelessly broadcast one or more instructions directly to a vehicle telematics control unit (TCU) 110 of the vehicle control system 104 via any form of messaging such as, but not limited to, an ultra-wide band network, Bluetooth®, WIFI, a CV2X protocol, a public cellular network, or a private cellular network, among others.

The one or more instructions may initiate the activation, or the deactivation, of one or more states of the vehicle 200. For example, the one or more states include a standby state, an on-state, a sleep state, or an off-state. However, it is understood that the one or more instructions may initiate the activation, or the deactivation, of any state associated with the vehicle 200. As an example, the fleet management system 102 may be additionally configured to wirelessly exchange (e.g., send/receive) data with the vehicle control system 104 via any form of messaging such as, but not limited to, an ultra-wide band network, Bluetooth®, WIFI, a CV2X protocol, a public cellular network, or a private cellular network, among others. As another example, the exchanged data may be associated with the one or more states of the vehicle 200.

The controller 108 of the fleet management system 102 is configured to centrally control the operation of the vehicle 200. For example, the operation of the vehicle 200 includes switching between each of the one or more states including the standby state, the on-state, the sleep state, or the off-state. It is understood that the controller 108 may be disposed within the fleet management system 102 or externally located relative to the fleet management system 102 (e.g., remote from the fleet management system 102). For example, the controller 108 is configured to cause the fleet management system 102 to wirelessly broadcast the one or more instructions to the vehicle control system 104.

As an example, the on-state of the vehicle 200 can be activated in response to a defined period of time elapsing (e.g., five minutes), according to a predetermined schedule (e.g., approximate time intervals wherein the vehicle 200 is expected to be in the on-state or based on production shift schedules), or the initiation of one or more remote commands received from a remote system (e.g., PC/PLC device or a web/phone application). As yet another example, it is understood that any of the one or more states associated with the vehicle 200 can be activated in response to the defined period of time elapsing, according to the predetermined schedule, or the initiation of one or more remote commands received from the remote system.

The vehicle control system 104 associated with the vehicle 200 generally includes the vehicle TCU 110, a vehicle central gateway module 112, a vehicle infotainment system 114, one or more vehicle sensors 116, a vehicle battery 118, a vehicle global navigation satellite system (GNSS) receiver 120, vehicle navigation maps 122, a vehicle CAN bus 124, and a wake-up module 126. The vehicle TCU 110 enables any component (e.g., the vehicle central gateway module 112, the vehicle infotainment system 114, the one or more vehicle sensors 116, the vehicle battery 118, the GNSS receiver 120, the vehicle navigation maps 122, the vehicle CAN bus 124, and the wake-up module 126) of the vehicle control system 104 to receive the broadcasted data and/or the one or more instructions from the fleet management system 102 via any messaging means, such as an ultra-wide band network, Bluetooth®, WIFI, a CV2X protocol, a public cellular network, or a private cellular network. As another example, the exchanged data may be associated with the one or more states of the vehicle 200.

The vehicle central gateway module 112 operates as an interface between various vehicle domain bus systems, such as an engine compartment bus (not shown), an interior bus (not shown), an optical bus for multimedia (not shown), a diagnostic bus for maintenance (not shown), or the vehicle CAN bus 124. The vehicle central gateway module 112 is configured to distribute data communicated to the vehicle central gateway module 112 by each of the various domain bus systems to other components of the vehicle 200. The vehicle central gateway module 112 is also configured to distribute information received from the fleet management system 102 to the various domain bus systems, via the vehicle TCU 110. The vehicle central gateway module 112 is further configured to send information to the fleet management system 102, via the vehicle TCU 110, received from the various domain bus systems. The vehicle control system 104 is additionally configured to utilize the vehicle TCU 110 to process and/or send information received from the vehicle central gateway module 112 to the fleet management system 102.

The vehicle infotainment system 114 is a system that delivers a combination of information and entertainment content and/or services to an operator (not shown) of the vehicle 200. It is understood that the vehicle infotainment system 114 can deliver entertainment content to the operator of the vehicle 200, in some examples. It is also understood that the vehicle infotainment system 114 can deliver information services to the operator of the vehicle 200, in other examples. In one or more examples, the vehicle infotainment system 114 includes built-in car computers that combine one or more functions, such as digital radios, built-in cameras, and/or televisions. The vehicle control system 104 is configured to utilize the vehicle TCU 110 to process and/or send information received from the vehicle infotainment system 114 to the fleet management system 102.

The one or more vehicle sensors 116 may be, for example, one or more of cameras, lidar, radar, and/or ultrasonic devices. For example, ultrasonic devices utilized as the one or more vehicle sensors 116 emit a high frequency sound wave that hits an object (e.g., a wall or another vehicle) and is then reflected back to the vehicle 200. Based on the amount of time it takes for the sound wave to return to the vehicle 200, the vehicle 200 can determine the distance between the one or more vehicle sensors 116 and the object. As another example, camera devices utilized as the one or more vehicle sensors 116 provide a visual indication of a space around the vehicle 200. As an additional example, radar devices utilized as the one or more vehicle sensors 116 emit electromagnetic wave signals that hit the object and is then reflected back to the vehicle 200. Based on the amount of time it takes for the electromagnetic waves to return to the vehicle 200, the vehicle 200 can determine a range, velocity, and angle of the vehicle 200 relative to the object. The vehicle control system 104 is configured to utilize the vehicle TCU 110 to process and/or send information received from the one or more vehicle sensors 116 to the fleet management system 102.

The vehicle battery 118 is controlled by a battery management system (not shown) that provides instructions to the vehicle battery 118. For example, the battery management system provides instructions to the vehicle battery 118 based on a temperature of the vehicle battery 118. The battery management system ensures acceptable current modes of the vehicle battery 118. For example, the acceptable current modes protect against overvoltage, overcharge, and/or overheating of the vehicle battery 118. As another example, the temperature of the vehicle battery 118 indicates to the battery management system whether any of the acceptable current modes are within acceptable temperate ranges. The vehicle control system 104 is configured to utilize the vehicle TCU 110 to process and/or send information received from the vehicle battery 118 to the fleet management system 102.

The vehicle TCU 110 includes a global navigation satellite system (GNSS) receiver 120 that is configured to communicate with one or more satellites (not shown) so that the vehicle control system 104 can determine a specific location of the vehicle 200. The GNSS receiver 120 is also configured to communicate with the one or more satellites so that the vehicle 200 can determine a specific location of the vehicle 200. The vehicle navigation maps 122 can display, via a display screen (not shown), the specific location of the vehicle 200 to the operator. The GNSS receiver 120 is further configured to gather geographical information associated with the vehicle 200. The vehicle control system 104 utilizes the vehicle TCU 110 to process and/or send information received from the GNSS receiver 120 to the fleet management system 102. The vehicle control system 104 additionally utilizes the vehicle TCU 110 to process and/or send information received from the vehicle navigation maps 122 to the fleet management system 102.

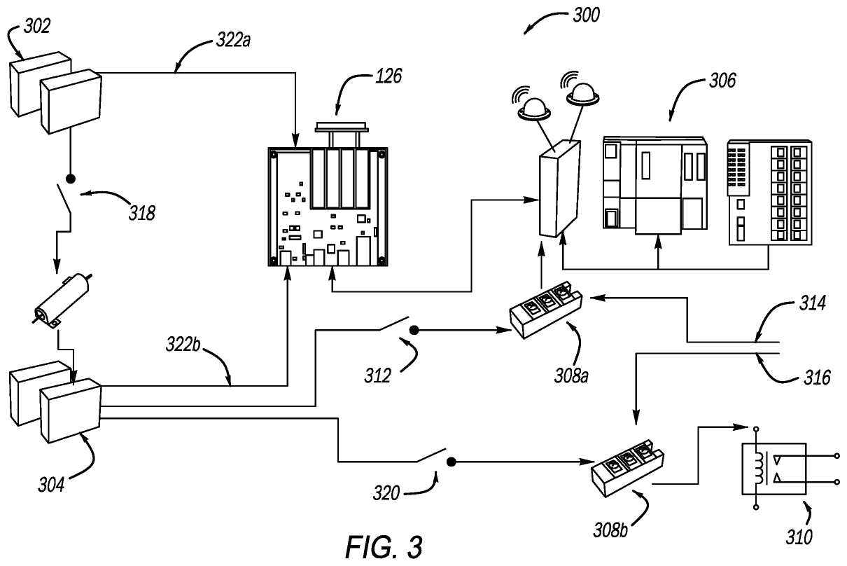

The wake-up module 126 is a transceiver module, in some examples, that is configured to operate by only utilizing low-amounts of power. For example, during a sleep state, the real-time clock of the wake-up module 126 operates based on a lithium-coin cell. As another example, at the wake-up check interval, the low-power circuit 320b operates at less than 30 volts (e.g., nominal 24 volts DC power that is not to exceed 12 watts). However, it is understood that the wake-up module 126 may operate at any level of power. The wake-up module 126 is coupled to a main power source (e.g., a main power source 302, shown in FIG. 3) via a low-power circuit (e.g., a low-power circuit 320a, shown in FIG. 3). The wake-up module 126 is also coupled to an auxiliary power source (e.g., an auxiliary power source 304, shown in FIG. 3) via the low-power circuit (e.g., a low-power circuit 320b, shown in FIG. 3). The wake-up module 126 is periodically activated so that the wake-up module 126 can determine whether a command associated with the activation or de-activation of any of the one or more states is broadcasted by the fleet management system 102. For example, the wake-up module 126 is activated in response to the defined period of time elapsing, according to the predetermined schedule, or the initiation of one or more remote commands received from the remote system.

Referring to FIG. 2, in various forms, the vehicle 200 may be powered in a variety of ways, for example, with an electric motor and/or an internal combustion engine. The vehicle 200 may be any type of vehicle powered by an electric motor and/or an internal combustion engine such as a car, a truck, a robot, a plane and/or a boat, as non-limiting examples. The vehicle 200 can include a vehicle controller 202, one or more vehicle actuators 204, a plurality of on-board sensors 206, and a human machine interface (HMI) 208. The vehicle 200 also has a reference point 210, that is, a specified point within the space defined by a vehicle body, for example, a geometrical center point at which respective longitudinal and lateral center axes of the vehicle 200 intersect. The reference point 210 identifies the location of the vehicle 200, for example, with a point at which the vehicle 200 is located as the vehicle 200 navigates toward a waypoint.

The vehicle controller 202, in some examples, is configured or programmed to control the operation of the brakes, propulsion (e.g., control of acceleration in the vehicle 200 by controlling one or more of an internal combustion engine, electric motor, hybrid engine, etc.), steering, climate control, interior and/or exterior lights, etc. of the vehicle 200, as well as to determine whether and when the vehicle controller 202, as opposed to a human operator, is to control such operations. It is understood that any of the operations associated with the vehicle 200 may be facilitated via an automated, a semi-automated, or a manual mode. For example, the automated mode may facilitate for any of the operations to be fully controlled by the vehicle controller 202 without the aid of the operator. As another example, the semi-automated mode may facilitate for any of the operations to be at least partially controlled by the vehicle controller 202 and/or the operator. As a further example, the manual mode may facilitate any of the operations being fully controlled by the operator.

The vehicle controller 202 includes or may be communicatively coupled to (e.g., via a vehicle communications bus) one or more processors, for example, controllers or the like included in the vehicle 200 for monitoring and/or controlling various vehicle controllers, such as a powertrain controller, a brake controller, a steering controller, etc. The vehicle controller 202 additionally includes or may be communicatively coupled to the one or more processors, for example, controllers or the like included in the vehicle 200 for monitoring and/or controlling information associated with the one or more states as described in more detail herein. The vehicle controller 202 is generally arranged for communications on a vehicle communication network that can include a bus in the vehicle 200 such as the CAN bus 124 or the like, and/or other wired and/or wireless mechanisms.

The vehicle controller 202 transmits messages, via a vehicle network, to various devices in the vehicle 200 and/or receives messages from the various devices, for example, the vehicle actuators 204, the HMI 208, etc. Alternatively, or additionally, in cases where the vehicle controller 202 includes multiple devices, the vehicle communication network is utilized for communications between devices represented as the vehicle controller 202. Further, as discussed below, various other controllers and/or sensors provide data to the vehicle controller 202 via the vehicle communication network.

In addition, the vehicle controller 202 is configured for communicating through a wireless vehicular communication interface with other traffic objects (e.g., vehicles, infrastructures, pedestrians, etc.), such as, via a vehicle-to-vehicle communication network. The vehicle controller 202 is also configured for communicating through a vehicle-to-infrastructure communication network, such as communicating with the controller 108 of the fleet management system 102. The vehicular communication network represents one or more mechanisms by which the vehicle controller 202 of the vehicle 200 communicates with other traffic objects, and may be one or more of wireless communication mechanisms, including any desired combination of wireless (e.g., cellular, wireless, satellite, microwave, and radio frequency) communication mechanisms and any desired network topology (or topologies when multiple communication mechanisms are utilized). Examples of vehicular communication networks include, among others, cellular, Bluetooth®, IEEE 802.11 , dedicated short range communications (DSRC), and/or wide area networks (WAN), including the Internet, providing data communication services.

The vehicle actuators 204 are implemented via circuits, chips, or other electronic and/or mechanical components that can actuate various vehicle subsystems in accordance with appropriate control signals. The vehicle actuators 204 may be used to control braking, acceleration, and/or steering of the vehicle 200. The vehicle controller 202 can be programmed to actuate the vehicle actuators 204 including propulsion, steering, and/or braking based on the planned acceleration or deceleration of the vehicle 200.

The plurality of on-board sensors 206 include a variety of devices to provide data to the vehicle controller 202. For example, the plurality of on-board sensors 206 may include object detection sensors such as lidar sensor(s) disposed on or in the vehicle 200 that provide relative locations, sizes, and shapes of one or more targets surrounding the vehicle 200, for example, additional vehicles, bicycles, pedestrians, robots, drones, etc., travelling next to, ahead, and/or behind the vehicle 200. As another example, the plurality of on-board sensors 206 can be radar sensors affixed to one or more bumpers of the vehicle 200 that may provide locations of the target(s) relative to the location of the vehicle 200.

The object detection sensors may include a camera sensor, for example, to provide a front view, side view, rear view, etc., providing images from an area surrounding the vehicle 200. For example, the vehicle controller 202 may be programmed to receive sensor data from a camera sensor(s) and to implement image processing techniques to detect a road, infrastructure elements, etc. The vehicle controller 202 may be further programmed to determine a current vehicle location based on location coordinates, for example, GPS coordinates, received from the vehicle 200 and indicative of a location of the vehicle 200 from a GPS sensor.

The HMI 208 is configured to receive information from a user, such as the operator, during operation of the vehicle 200. Moreover, the HMI 208 is configured to present information to the user, such as, an occupant of the vehicle 200. In some variations, the vehicle controller 202 is programmed to receive destination data, for example, location coordinates, from the HMI 208.

Accordingly, the one or more states of the vehicle 200 can be remotely controlled or switched (e.g., remotely activated or deactivated). For example, the fleet management system 102 can utilize any of the vehicle controller 202, the vehicle actuators 204, the plurality of on-board sensors 206, the HMI 208, and/or the reference point 210 to cause the vehicle 200 in the standby state to switch to the on-state. It is understood, however, that the fleet management system 102 can cause the vehicle 200 to switch between any of the one or more states from any of the other one or more states (e.g., from the sleep state to the on-state).

FIG. 3 depicts a functional block diagram, illustrating an example of a manufacturing environment 300 of the communicative system 100 described in FIG. 1. For example, the manufacturing environment 300 employs a global wakeup function and generally includes the fleet management system 102, a programmable logic controller (PLC) system 306, and a fleet of autonomous guided vehicles (AGV) (not shown). For example, each AGV of the fleet of AGVS may be represented by the vehicle 200.

Each AGV of the fleet of AGVs includes the main power source 302, the auxiliary power source 304, the wake-up module 126, a programmable logic controller (PLC) system 306, diode bridges 308a, 308b, and a control relay 310. The fleet management system 102 is communicably coupled to the wake-up module 126 of each of the AGVS of the fleet of AGVs via an enable Wi-Fi module 312, a Wi-Fi power circuit 314 and the diode bridge 308a. Each of the one or more states are controlled by a power-on circuit 316, the diode bridge 308b, an enable charger module 318, and a power on AGV module 320.

The wake-up module 126 is coupled to the main power source 302 via the low-power circuit 322a. The wake-up module 126 is also coupled to the auxiliary power source 304 via the low-power circuit 322b. The wake-up module 126 is periodically activated so that the wake-up module 126 can determine whether a command associated with the activation or de-activation of any of the one or more states is broadcasted by the fleet management system 102. For example, the wake-up module 126 is activated in response to the defined period of time elapsing, according to the predetermined schedule, or the initiation of one or more remote commands received from the remote system.

In one example, the wake-up module 126 is configured to be powered (e.g., charged) by the auxiliary power source 304 when the AGV is in any state other than the on-state. As an example, in an instance wherein the AGV is in the standby state, the wake-up module 126 is configured to be powered by the auxiliary power source 304. In the instance wherein the AGV is in the standby state, the wake-up module 126 is further configured to be periodically activated by activating the enable Wi-Fi module 312 and the diode bridge 308a so that the wake-up module 126 can determine whether the command associated with the activation of the on-state (e.g., a global wake-up command) was broadcasted by the fleet management system 102. In another example, the command may be stored in a database (not shown). For example, when the wake-up module 126 becomes active, the vehicle 200 can communicate with the database to determine whether the command was broadcasted by the fleet management system 102 while the wake-up module 126 was inactive. As another example, the database can be disposed within the fleet management system 102, within the vehicle 200 itself, or external from both the fleet management system 102 and the vehicle 200.

If the wake-up module 126 determines that the command was not broadcasted by the fleet management system 102, the wake-up module 126 remains in the standby state. However, when the wake-up module 126 determines that the command was broadcasted by the fleet management system 102, the wake-up module 126 activates the AGV (e.g., causes the AGV to enter the on-state) by activating the diode bridge 308b, via the power-on circuit 316, and the control relay 310. As an example, in the instance wherein the AGV is in the on-state, the wake-up module 126 is configured to be powered by the main power source 302.

The wake-up module 126 continues to listen for any commands broadcasted from the fleet management system 102 while the AGV is in the on-state (e.g., continues to receive broadcasted signals). If the wake-up module 126 determines that the command associated with the activation of the off-state (e.g., a global shut-off command) was broadcasted by the fleet management system 102, the sleep state associated with the AGV is activated. Alternatively, if the wake-up module 126 determines that the command associated with the activation of the off-state (e.g., a global shut-off command) was broadcasted by the fleet management system 102, the standby state associated with the AGV can be activated.

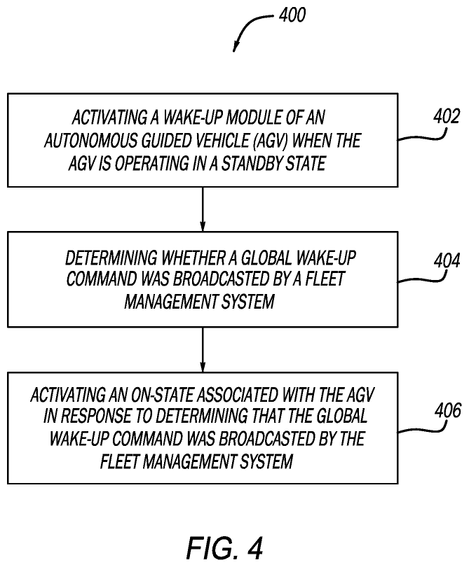

FIG. 4 is a flowchart illustrating an example method 400 for remotely waking up a fleet of vehicles (e.g., the vehicle 200). At operation 402, a wake-up module (e.g., the wake-up module 126) of an AGV is activated. For example, the wake-up module of the AGV is activated when the AGV is operating in a standby state. As another example, the activation of the wake-up module is in response to a defined period of time elapsing, according to a predetermined schedule, or an initiation of a remote command. As an additional example, the wake-up module is coupled to a first low-power circuit (e.g., the low-power circuit 322a) associated with the AGV.

At operation 404, a determination is made regarding whether a global wake-up command was broadcasted by a fleet management system (e.g., the fleet management system 102). For example, the determination of whether the global wake-up command was broadcasted by the fleet management system is made by the wake-up module. As another example, the global wake-up command is broadcasted via an ultra-wide band network, Bluetooth®, WIFI, a CV2X protocol, a public cellular network, or a private cellular network. In another example, the global wake-up command may be stored in a database (not shown). For example, when the wake-up module becomes active, the AGV can communicate with the database to determine whether the command was broadcasted by the fleet management system while the wake-up module was inactive. As another example, the database can cause a flag to activate upon the activation of the wake-up module if the database is storing the broadcasted command so that the wake-up module knows that the global wake-up command was broadcasted by the fleet management system while the wake-up module was inactive. As yet another example, the wake-up module can determine whether the global wake-up command is broadcasted by the fleet management system in real-time in a case wherein the global wake-up command is broadcasted while the wake-up module is active.

At operation 406, an on-state associated with the AGV is activated. For example, the on-state associated with the AGV is activated in response to determining that the global wake-up command was broadcasted by the fleet management system. As another example, the wake-up module is caused to be charged via a main power source (e.g., the main power source 302) associated with the AGV in an instance wherein the on-state associated with the AGV is activated. As yet another example, the first low-power circuit is additionally coupled to the main power source in the on-state.

In one or more examples, the standby state associated with the AGV is activated in response to a global shut-off command broadcasted by the fleet management system. For example, the wake-up module is then activated in response to a defined period of time elapsing, according to a predetermined schedule, or an initiation of a remote command. As yet another example, the wake-up module is powered by an auxiliary power source (e.g., the auxiliary power source 304) in the instance wherein the AGV is operating in the standby state. As a further example a sleep state associated with the AGV is activated in response to determining that the global wake-up command was not broadcasted by the fleet management system. The wake-up module is re-activated (e.g., from the sleep state) when the AGV is operating in a standby state and/or in response to a defined period of time elapsing, according to a predetermined schedule, or an initiation of a remote command, for example. As another example, a second low-power circuit (e.g., the low-power circuit 322b) couples the wake-up module to the auxiliary power source.

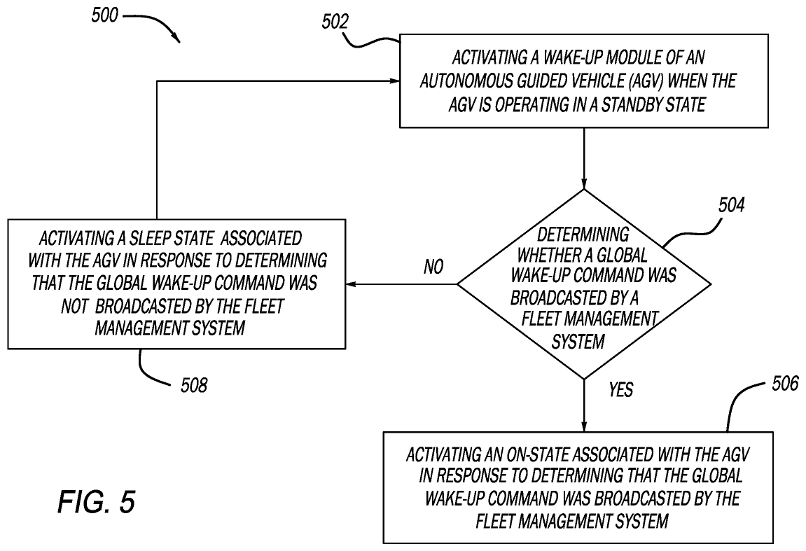

FIG. 5 is a flowchart illustrating an example method 400 for remotely waking up a fleet of vehicles (e.g., the vehicle 200). At operation 502, a wake-up module (e.g., the wake-up module 126) of an AGV is activated when the AGV is operating in a standby state. At operation 504, a determination is made regarding whether a global wake-up command was broadcasted by a fleet management system (e.g., the fleet management system 102). For example, the determination of whether the global wake-up command was broadcasted by the fleet management system is made by the wake-up module. In an instance wherein the wake-up module determines that the global wake-up command was broadcasted by the fleet management system, an on-state associated with the AGV is activated at operation 506.

In an instance wherein the wake-up module determines that the global wake-up command was not broadcasted by the fleet management system, a sleep state associated with the AGV is activated at operation 508. It is understood that operations 502 and 504 are repeated until the wake-up module determines that the global wake-up command was broadcasted by the fleet management system. For example, operations 502 and 504 are repeated periodically based on a defined period of time elapsing, according to a predetermined schedule, or an initiation of one or more remote commands received from a remote system.

In some examples, to perform the global wakeup functionality described herein, a method for keeping a communication connection active between powered down AGVs and the fleet management system is established. To maintain communication between the AGVs and the fleet management system, instead of keeping the AGVs powered on, the wake-up module is powered on after a predetermined time period elapses and, in some instances, periodically. As an example, the wake-up module is periodically powered on every five minutes. When powered on, the wake-up module activates the enable Wi-Fi module and one of the diode bridges to determine whether a global wake-up command from the fleet management system has been issued/broadcasted. For example, the wake-up module determines whether the global wake-up command from the fleet management system has been issued/broadcasted based on communicating with a database that stores the broadcasted wake-up command when the wake-up module is inactive or based on receiving the wake-up command in real-time. When the global wake up command is broadcasted/issued, the wake-up module activates the power on AGV module, one of the diode bridges, and the control relay to power on the AGV (e.g., the AGV operates in the ON state). When the global wake up command is not issued/broadcasted, the wake-up module maintains the AGV in a standby state (e.g., the AGV remains powered down), and the wake-up module is turned off until the predetermined time period elapses. When the AGV is fully powered on, the wake-up module is charged by the main AGV power source and via the enable charge module. The AGV does not draw power from the main AGV power source when the AGV is powered down and is powered by the reserve AGV battery instead.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
activating a wake-up module of an autonomous guided vehicle (AGV) when the AGV is operating in a standby state;
determining, by the wake-up module, whether a global wake-up command was broadcasted by a fleet management system; and
activating an on-state associated with the AGV in response to determining that the global wake-up command was broadcasted by the fleet management system.

2. The method of claim 1, wherein the wake-up module is coupled to a first low-power circuit associated with the AGV and wherein the global wake-up command is broadcasted via an ultra-wide band network, Bluetooth®, WIFI, a CV2X protocol, a public cellular network, or a private cellular network.

3. The method of claim 2, wherein activating the on-state associated with the AGV further comprises:
causing the wake-up module to be charged via a main power source associated with the AGV, wherein the first low-power circuit is coupled to the main power source.

4. The method of claim 1, further comprising:
activating the standby state associated with the AGV in response to a global shut-off command broadcasted by the fleet management system;
activating the wake-up module, wherein the wake-up module is powered by an auxiliary power source;
determining whether the global wake-up command was broadcasted by the fleet management system; and
activating a sleep state associated with the AGV in response to determining that the global wake-up command was not broadcasted by the fleet management system.

5. The method of claim 4, further comprising:
re-activating the wake-up module when the AGV is operating in a standby state and in response to a defined period of time elapsing, according to a predetermined schedule, or an initiation of a remote command.

6. The method of claim 4, wherein a second low-power circuit couples the wake-up module to the auxiliary power source.

7. The method of claim 1, wherein activating the wake-up module of the AGV is in response to a defined period of time elapsing, according to a predetermined schedule, or an initiation of a remote command.

8. A system comprising:
a vehicle control system configured to:
activate a wake-up module of an autonomous guided vehicle (AGV) when the AGV is operating in a standby state,
determine, by the wake-up module, whether a global wake-up command was broadcasted by a fleet management system, and
activate an on-state associated with the AGV in response to determining that the global wake-up command was broadcasted by the fleet management system; and
a fleet management system configured to:
broadcast the global wake-up command.

9. The system of claim 8, wherein the wake-up module is coupled to a first low-power circuit associated with the AGV and wherein the global wake-up command is broadcasted via an ultra-wide band network, Bluetooth®, WIFI, a CV2X protocol, a public cellular network, or a private cellular network.

10. The system of claim 9, wherein the vehicle control system is further configured to:
cause the wake-up module to be charged via a main power source associated with the AGV, wherein the first low-power circuit is coupled to the main power source.

11. The system of claim 8, wherein the vehicle control system is further configured to:
activate the standby state associated with the AGV in response to a global shut-off command broadcasted by the fleet management system;
activate the wake-up module, wherein the wake-up module is powered by an auxiliary power source;
determine whether the global wake-up command was broadcasted by the fleet management system; and
activate a sleep state associated with the AGV in response to determining that the global wake-up command was not broadcasted by the fleet management system.

12. The system of claim 11, wherein the vehicle control system is further configured to:
re-activate the wake-up module when the AGV is operating in a standby state and in response to a defined period of time elapsing, according to a predetermined schedule, or an initiation of a remote command.

13. The system of claim 11, wherein a second low-power circuit couples the wake-up module to the auxiliary power source.

14. The system of claim 8, wherein activating the wake-up module of the AGV is in response to a defined period of time elapsing, according to a predetermined schedule, or an initiation of a remote command.

15. One or more non-transitory computer-readable media storing processor-executable instructions that, when executed by at least one processor, cause the at least one processor to:
activate a wake-up module of an autonomous guided vehicle (AGV) when the AGV is operating in a standby state;
determine, by the wake-up module, whether a global wake-up command was broadcasted by a fleet management system; and
activate an on-state associated with the AGV in response to determining that the global wake-up command was broadcasted by the fleet management system.

16. The one or more non-transitory computer-readable media of claim 15, wherein the wake-up module is coupled to a first low-power circuit associated with the AGV and wherein the global wake-up command is broadcasted via an ultra-wide band network, Bluetooth®, WIFI, a CV2X protocol, a public cellular network, or a private cellular network.

17. The one or more non-transitory computer-readable media of claim 16, wherein the processor-executable instructions that, when executed by the at least one processor, activate the on-state associated with the AGV, further causes the at least one processor to:
cause the wake-up module to be charged via a main power source associated with the AGV, wherein the first low-power circuit is coupled to the main power source.

18. The one or more non-transitory computer-readable media of claim 15, wherein the at least one processor is further caused to:
activate the standby state associated with the AGV in response to a global shut-off command broadcasted by the fleet management system;
activate the wake-up module, wherein the wake-up module is powered by an auxiliary power source and wherein a second low-power circuit couples the wake-up module to the auxiliary power source;
determine whether the global wake-up command was broadcasted by the fleet management system; and
activate a sleep state associated with the AGV in response to determining that the global wake-up command was not broadcasted by the fleet management system.

19. The one or more non-transitory computer-readable media of claim 18, wherein the at least one processor is further caused to:
re-activate the wake-up module when the AGV is operating in a standby state and in response to a defined period of time elapsing, according to a predetermined schedule, or an initiation of a remote command.

20. The one or more non-transitory computer-readable media of claim 15, wherein activating the wake-up module of the AGV is in response to a defined period of time elapsing, according to a predetermined schedule, or an initiation of a remote command.
